(19) United States
(12) Patent Application Publication
(10) Pub. No.: US 2010/0277400 A1
(43) Pub. Date: Nov. 4, 2010

(54) CORRECTION OF AGING IN AMOLED DISPLAY

(75) Inventor: Koanyel Jeong, San Jose, CA (US)

Correspondence Address: FENWICK & WEST LLP, SILICON VALLEY CENTER, 801 CALIFORNIA STREET, MOUNTAIN VIEW, CA, 94041, US

(73) Assignee: LEADIS TECHNOLOGY, INC., Sunnyvale, CA (US)

(21) Appl. No.: 12/434,383

(22) Filed: May 1, 2009

(51) Int. Cl. G09G 3/30

(52) U.S. Cl. 345/76

(57) ABSTRACT

The data line voltage on the data line of the AMOLED sub-pixels is measured while the OLED is being driven by a reference current, in order to determine the age of the OLED in the sub-pixel. The pixel transistor serves as a current source for driving the OLED in the sub-pixel with the reference current. The data line voltage is substantially equal to the forward voltage VF(aged) of the aged OLED being driven at the reference current. The forward voltage VF (un-aged) of a reference (un-aged) OLED sub-pixel also measured at the reference current, and is subtracted from the measured OLED diode forward voltage VF (aged) to obtain their difference ΔVF=VF(aged)−VF(un-aged). ΔVF is an indicator of the age of the OLED in the sub-pixel, and is used as an index to a look-up-table that stores the corresponding aging offset data for generating the incremental pixel current needed to maintain constant luminance in the aged OLED pixel.

### BACKGROUND OF THE INVENTION

1. Field of the Invention

The present invention relates to calibration of current variations in the pixels/sub-pixels of an active matrix organic light-emitting diode (AMOLED) display caused by aging of the organic light-emitting diodes (OLEDs) in the AMOLED sub-pixels.

2. Description of the Related Arts

An OLED display is generally comprised of an array of organic light emitting diodes (hereafter referred to as “OLED diodes”) that have carbon-based films deposited between two charged electrodes. Generally one electrode is comprised of a transparent conductor, for example, indium tin oxide (ITO). Generally, the organic material films are comprised of a hole-injection layer, a hole-transport layer, an emissive layer and an electron-transport layer. When voltage is applied to the OLED diode, the injected positive and negative charges recombine in the emissive layer and transduce electrical energy to light energy. Unlike liquid crystal displays (LCDs) that require backlighting, OLED displays are self-emissive devices—they emit light rather than modulate transmitted or reflected light. Accordingly, OLEDs are brighter, thinner, faster and lighter than LCDs, and use less power, offer higher contrast and are cheaper to manufacture.

An OLED display typically includes a plurality of OLED diodes arranged in a matrix form including a plurality of rows and a plurality of columns, with the intersection of each row and each column forming a pixel of the OLED display. An OLED display is generally activated by way of a current driving method that relies on either a passive-matrix (PM) scheme or an active-matrix (AM) scheme.

In a passive matrix OLED (PM OLED) display, a matrix of electrically-conducting rows and columns forms a two-dimensional array of picture elements called pixels. Sandwiched between the orthogonal column and row lines are thin films of organic material of the OLEDs that are activated to emit light when current is applied to the designated row and column lines. The brightness of each pixel is proportional to the amount of current applied to the OLED diodes of the pixel. While PM OLEDs are fairly simple structures to design and fabricate, they demand relatively expensive, current-sourced drive electronics to operate effectively and are limited as to the number of lines because only one line can be on at a time and therefore the PM OLED must have instantaneous brightness equal to the desired average brightness times the number of lines. Thus, PM OLED displays are typically limited to under 100 lines. In addition, their power consumption is significantly higher than that required by an active-matrix OLED. PM OLED displays are most practical in alpha-numeric displays rather than higher resolution graphic displays.

An active-matrix OLED (AMOLED) display is comprised of OLED pixels (that are each comprised of R, G, B sub-pixels) that have been deposited or integrated onto a thin film transistor (TFT) array to form a matrix of pixels that emit light upon electrical activation. In contrast to a PM OLED display, for which electricity is distributed row by row, the active-matrix TFT backplane acts as an array of switches coupled with sample and hold circuitry that control and hold the amount of current flowing through each individual OLED sub-pixel during the total frame time. The active matrix TFT array continuously controls the current that flows to the OLED diodes in each of the sub-pixels, signaling to each pixel how brightly to illuminate.

AMOLED displays require regulated current in each pixel to produce a desired brightness from the pixel. Ideally, the TFTs in the active matrix TFT array exhibit uniform electrical characteristics, so that the AMOLED display can be precisely controlled in a uniform manner. However, the TFTs in the AMOLED are typically fabricated with poly-silicon (p-Si) that is difficult to fabricate in a uniform manner. This is because p-Si is made by converting amorphous silicon (a-Si) to p-Si by laser annealing the a-Si to increase the crystal grain size. The larger the crystal grain size, the faster and more stable is the resulting semiconductor material. Unfortunately the grain size produced in the laser anneal step is not uniform due to a temperature spread in the laser beam. Thus, uniform TFTs are very difficult to produce and thus the current supplied by TFTs in conventional AMOLED displays is often non-uniform, resulting in non-uniform display brightness. TFT non-uniformity throughout the OLED display causes “Mura” (streaking or spots) in the OLED displays made with p-Si TFTs. In other words, TFTs may produce different OLED currents due to their non-uniformities from pixel to pixel, even if the same gate voltage is applied to the TFTs.

Another problem with AMOLED displays occurs due to aging of the material in the OLEDs. As the OLED diode in each sub-pixel ages with use, it becomes less efficient in converting current to light, i.e., the efficiency of light emission of the OLED diode decreases. Thus, as OLED diode current to light efficiency of the OLED material decreases with use (age), light (luminance) emitted from an OLED diode in each sub-pixel for a given gate voltage applied to the drive TFTs of the OLED display also decreases. As a result, the OLED display emits less light for display than desired in response to a given gate voltage applied to the drive TFTs. In addition, since the OLED diodes on various parts of the AMOLED display do not age (are not used) equally in a uniform manner, OLED aging also causes non-uniformity in the OLED display. In addition, since aging is accelerated at higher currents, a repeating image at a high gray level will appear to remain or stick on the AMOLED panel, hence the term “image sticking” due to aging. As a result of aging, the forward voltage VF of an OLED in a sub-pixel required to generate a given OLED current will increase. Also, given an OLED current, the luminance from the OLED will decrease. The present invention seeks to correct such problems in the AMOLED display that arise from aging of the OLEDs in the AMOLED sub-pixels.

### SUMMARY OF THE INVENTION

According to various embodiments of the present invention, the data line voltage on the data line of the AMOLED sub-pixels is measured while the OLED is being driven by a reference current in order to determine the age of the OLED in the sub-pixel. The pixel transistor serves as a current source for driving the OLED in the sub-pixel with the reference current. The data line voltage is substantially equal to the forward voltage VF(aged) of the aged OLED being driven at the reference current. The forward voltage VF (un-aged) of a reference (un-aged) OLED sub-pixel also measured at the reference current, and is subtracted from the measured OLED diode forward voltage VF (aged) to obtain their difference ΔVF=VF(aged)−VF(un-aged). ΔVF is an indicator of the age of the OLED in the sub-pixel, and is used as an index to a look-up-table that stores the corresponding aging offset data for generating the incremental pixel current needed to maintain constant luminance in the aged OLED pixel.

The features and advantages described in the specification are not all inclusive and, in particular, many additional features and advantages will be apparent to one of ordinary skill in the art in view of the drawings and specification. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates a sub-pixel structure of an AMOLED display, according to one embodiment.

FIG. 2 illustrates the configuration of an AMOLED panel including OLED sub-pixels with the pixel structure of FIG. 1, according to one embodiment.

FIG. 3A illustrates an EPIC DDI (Electrical Pixel Correction Display Driver IC) driving an AMOLED panel, according to one embodiment.

FIG. 3B illustrates the multiplexer in the EPIC DDI of FIG. 3A in more detail, according to one embodiment.

FIG. 4A illustrates an image sticking (aging) calibration circuit in more detail, according to one embodiment.

FIG. 4B illustrates one example of the analog-to-digital converter (ADC) that can be used with the image sticking calibration circuit of FIG. 4A, according to one embodiment.

FIG. 5 illustrates how un-aged reference pixels are included in the AMOLED display, according to one embodiment.

FIG. 6 illustrates a method of measuring the forward voltage of an OLED in an AMOLED sub-pixel for aging calibration, according to one embodiment.

FIG. 7 illustrates the addition of compensation data to real-time display data, according to one embodiment.

### DETAILED DESCRIPTION OF EMBODIMENTS

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

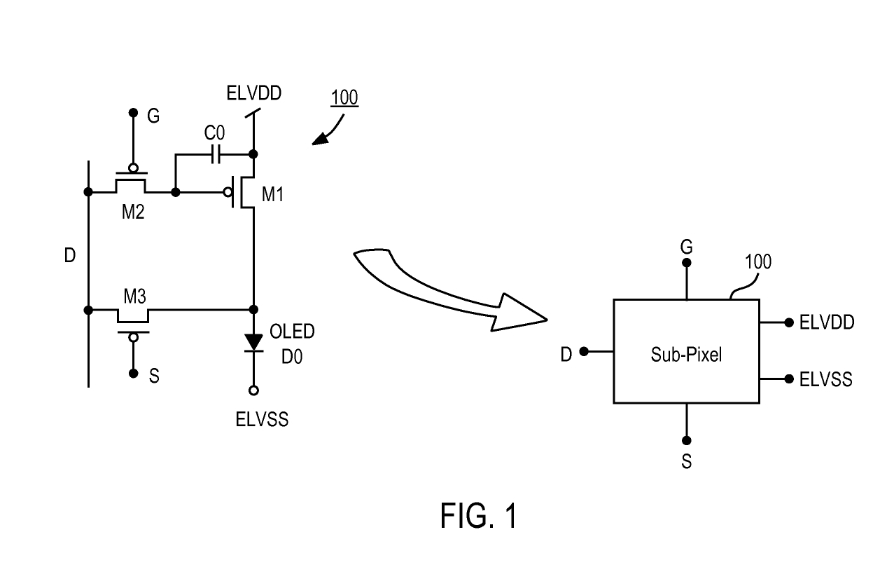

FIG. 1 illustrates a sub-pixel structure of an AMOLED display, according to one embodiment of the present invention. For a color AMOLED display, each pixel includes 3 sub-pixels that have identical structure but emit different colors (R, G, B). For simplicity of illustration, FIG. 1 illustrates only one sub-pixel corresponding to one of the R, G, B colors per sub-pixel at the intersection of each row and each column of the AMOLED display panel. As shown in FIG. 1, the active drive circuitry of each sub-pixel 100 includes TFTs M1, M2, and M3 and a storage capacitor C0 for driving the OLED diode D0 of the sub-pixel. In the following explanation of FIG. 1 and ensuing figures, the type of the TFTs M1, M2, M3 is p-channel TFT. However, note that n-channel TFTs may also be utilized in the active matrix.

The source of TFT M2 is connected to data line D, and the drain of TFT M2 is connected to the gate of TFT M1 (the “pixel transistor”) and to one side of storage capacitor C0. The source of TFT M1 is connected to positive supply voltage ELVDD. The other side of storage capacitor C0 is also connected, for example, to the positive supply voltage ELVDD and to the source of TFT M1. Note that the storage capacitor C0 may be tied to any reference electrode in the pixel, but the connection shown in FIG. 1 has performance benefits in the presence of ELVDD positive supply voltage noise. The drain of TFT M0 is connected to the anode of the OLED diode D0. The cathode of the OLED diode D0 is connected to negative supply voltage ELVSS. The source of TFT M3 is connected to the anode of OLED diode D0, and the drain of TFT M3 is connected to data line D. The data line D voltages are downloaded to the AMOLED display a row at a time for display.

When TFT M2 is turned on, the analog gate voltage from the data line D is applied to the gate of each TFT M1 of each sub-pixel, which is locked by storage capacitor C0. In other words, the continuous current flow to the OLED diodes is controlled by the two TFTs M1, M2 of each sub-pixel. TFT M2 is used to start and stop the charging of storage capacitor C0, which provides a voltage source to the gate of TFT M1 at the level needed to create a constant current to the OLED diode. The TFT M2 samples the data on the data line D, which is then transferred to and held by the storage capacitor C0. The voltage held on the storage capacitor C0 is applied to the gate of the TFT M1. In response, TFT M1 drives current through the OLED diode D0 to a specific brightness depending on the value of the sampled and held voltage as stored in the storage capacitor C0.

In addition to the two TFTs M1, M2 typically found in conventional AMOLED cells (“2T cell structure”), the AMOLED sub-pixel of the present invention employs a “3T cell structure” that additionally includes a third TFT M3 with one additional control line S that can be used to control the gate voltage of TFT M3. As will be explained in more detail below, TFT M3, when turned on, enables the forward voltage of OLED D0 to be measured via the data line D. Thus, the AMOLED display of the present invention uses “data line sensing” to sense the OLED forward voltage. As shown in FIG. 1, each sub-pixel 100 may be represented as a circuit block with 5 terminals, i.e., TFT M2 gate voltage G, data line voltage D, M3 gate voltage S, and ELVDD and ELVSS.

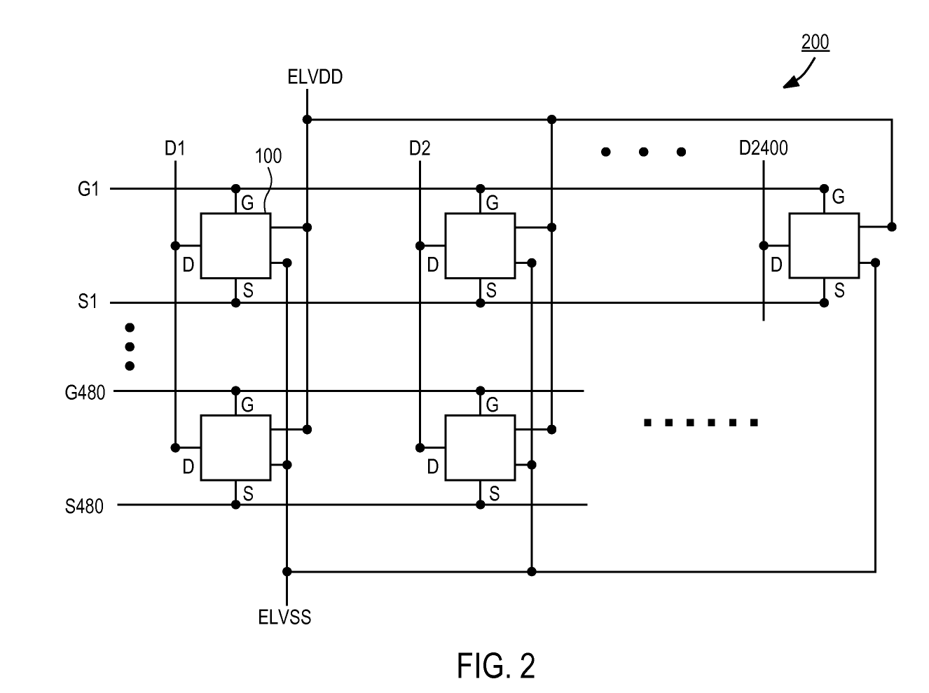

FIG. 2 illustrates the configuration of an AMOLED display panel including OLED sub-pixels with the sub-pixel structure of FIG. 1, according to one embodiment of the present invention. The AMOLED display panel 200 is for a 480×800 RGB AMOLED, although this present invention can be used with AMOLED panels with any other size. Each sub-pixel structure 100 corresponds to that shown in FIG. 1. Each of 3 sub-pixels is supplied by a dedicated data line D1, D2, . . . , D2400 corresponding to each of R, G, B. All the supply voltage lines corresponding to the 2400 columns (800 columns×3 colors) D1, D2, . . . , D2400 are powered by a common ELVDD supply voltage line. Thus, one column contains 3 data lines. Also note that one additional control line (S1, S2, . . . , S480) is added to each row, to control the TFTs M3 in each sub-pixel and achieve data line sensing of the OLED diode current or the pixel transistor current in each sub-pixel via the corresponding data lines D1, D2, . . . , D2400.

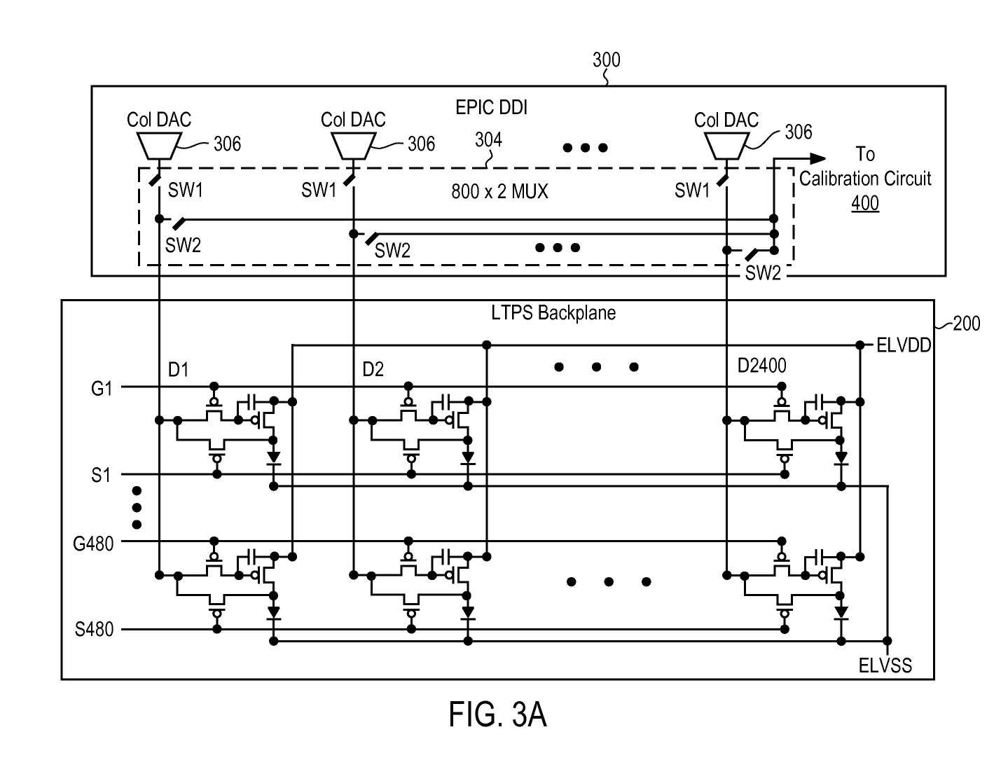

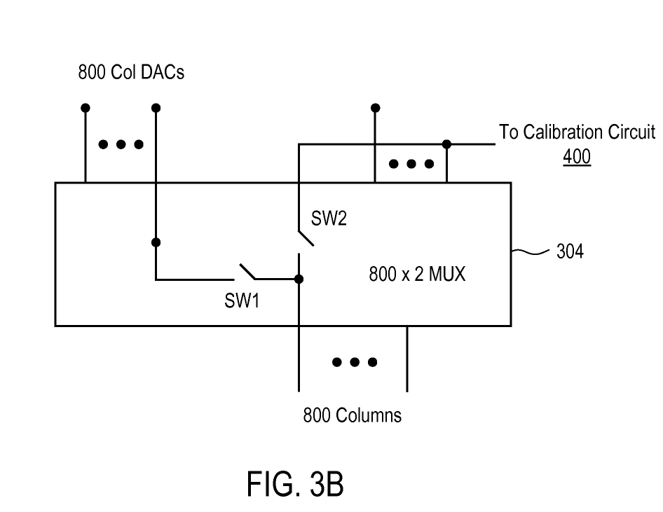

FIG. 3A illustrates a EPIC DDI (Electrical Pixel Correction Display Driver IC) driving an AMOLED panel 200, according to one embodiment of the present invention. EPIC DDI 300 includes 800 column DACs (Digital-to-Analog Converters) 306 corresponding to the data lines (D1, D2, . . . , D2400), in groups of 3, of the AMOLED panel 200 (LTPS backplane). Each of 800 column DACs 306 can address 3 data lines by using a 1-to-3 RGB MUX (not shown in FIG. 3A). Thus all 2400 data lines D1, D2, . . . , D2400 can be addressed. An 800×2 multiplexer 304 is used to divert pixel current to a calibration circuit 400. Multiplexer 304 includes switches SW1, SW2 for each column. Switch SW1 connects or disconnects the column DAC 306 to/from the corresponding column, and switch SW2 connects or disconnects the calibration circuit 400 to or from the corresponding column (data line) to sense the OLED diode forward voltage for image sticking calibration of each sub-pixel via the selected data line (D1, D2, . . . D2400).

FIG. 3B illustrates the multiplexer (MUX) 304 in the EPIC DDI of FIG. 3A in more detail, according to one embodiment of the present invention. As shown in FIG. 3B, the MUX 304 is a 800×2 MUX each having two switches, SW1 and SW2 corresponding to each of the 800 columns of the AMOLED. MUX 304 connects the column DAC 306 to the corresponding column for normal operation using switch SW1, and connects a selected column to the calibration circuit 400 for OLED forward voltage measurement for aging (image sticking) calibration using switch SW2. Specifically, switches SW1 in MUX 304 connect each of 800 column DACs 306 to each of 800 columns of the AMOLED panel. Switches SW2 in MUX 304 allow each of the columns to be switched sequentially to a single calibration circuitry 400 so that one calibration circuitry can be used to calibrate all the sub-pixels in the AMOLED panel 200. Although one calibration circuitry is used in the following description herein, multiple calibration circuitry may also be used to reduce image sticking calibration time at the expense of the additional circuitry.

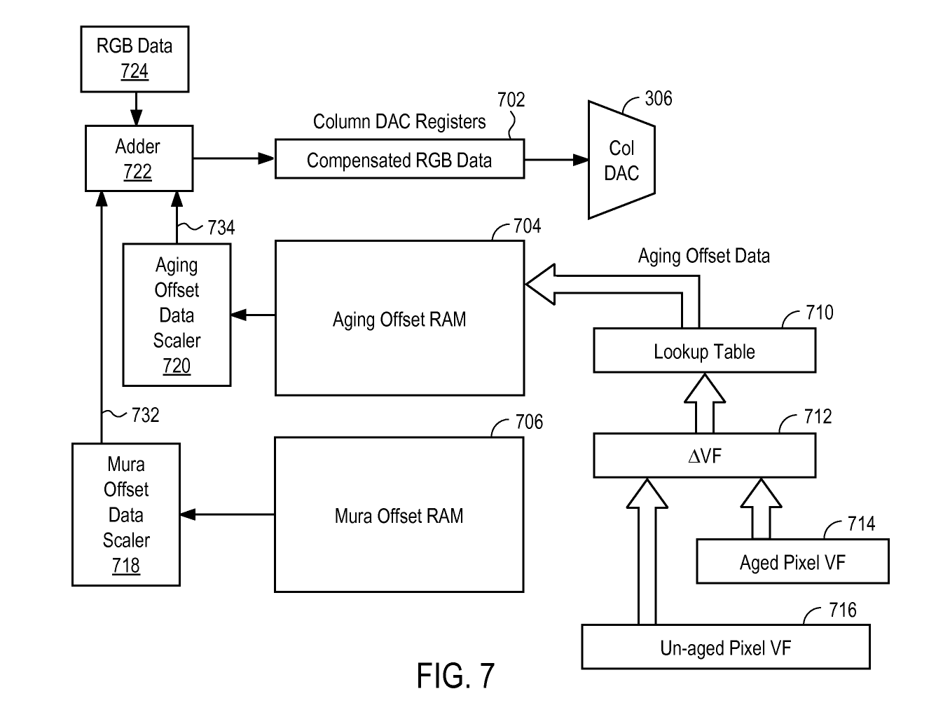

Turning to the OLED aging problem, as mentioned briefly above, OLEDs age over time, resulting in increase of the forward voltage VF across OLED diode D0 for a given OLED diode current (If). Also, even if the OLED diode is operated at constant current (If), the luminance from the OLED diode will decrease as a result of aging. Since aging is accelerated at higher currents, a repeating image at a high gray level will appear to remain or stick on the AMOLED panel, hence the term “image sticking” due to aging. By measuring the forward voltage (VF) across the OLED diode D0 at a constant current and temperature for each pixel over time as the OLED diode ages, the amount of lost luminance from OLED aging can be inferred from ΔVF, i.e., the change in the OLED diode forward voltage (VF) over time at a constant OLED diode current (If) as the AMOLED display ages. Alternatively, the OLED diode forward voltage VF(un-aged) of an un-aged OLED diode can be measured and then this value can be subtracted from the measured OLED diode forward voltage VF(aged) of an aged, active sub-pixel to obtain ΔVF, i.e., ΔVF=VF(aged)−VF(un-aged), which method is preferred since it cancels temperature dependence. Then, as will be explained in more detail below with reference to FIG. 7, ΔVF can be used as an index into a look-up-table that stores values of ΔVF and the corresponding aging offset data for generating the incremental sub-pixel current needed to maintain constant luminance in the aged OLED sub-pixel. Such look-up-table data is generated from OLED diode aging characterization data empirically obtained at the manufacturing and testing stage of the AMOLED display. This additional sub-pixel current can be implemented with an Aging Offset RAM that contains the digital offset that is to be added to the average RGB data in order to obtain the desired constant luminance over time. By using a target current equal to the full-scale luminance (full-scale RGB data) the aging offset RAM value can be scaled appropriately for smaller RGB data.

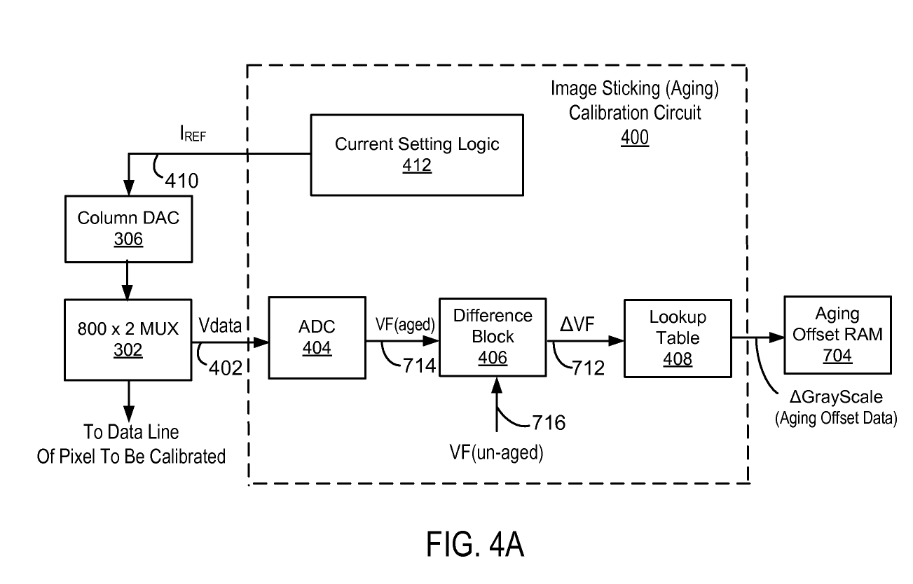

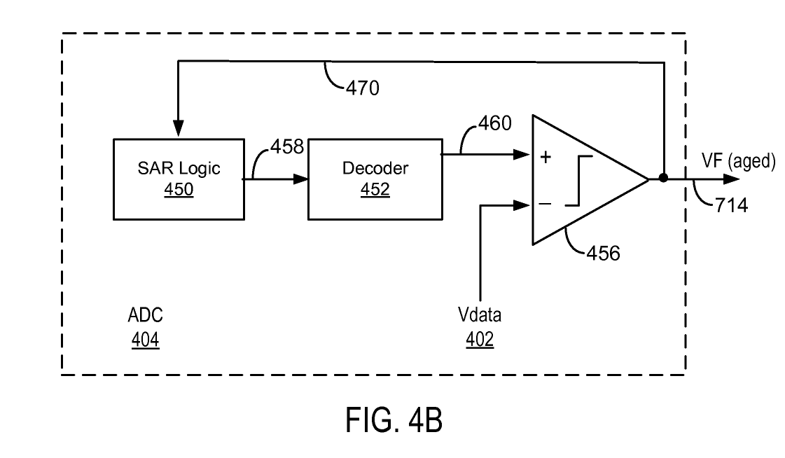

As can be seen above, the success of the aging compensation technique depends upon the ability to measure the OLED diode forward voltage VF at a constant current over time as the AMOLED ages. It is expected that 5 or more “image sticking” calibrations should be performed over the lifetime of the AMOLED product. Such calibrations may occur at, for example, 100 hours, 200 hours, 300 hours, 500 hours, and 1000 hours of use (depending upon the lifetime of the display). FIG. 4A illustrates an image sticking (aging) calibration circuit that is used to measure such OLED diode forward voltage VF, according to one embodiment. Referring to FIG. 4A, aging calibration circuit 400 includes current setting logic 412, ADC 404, difference block 406, and lookup table 408. Aging calibration circuit 400 also interfaces with column DAC 306, MUX 302, and aging offset RAM 704.

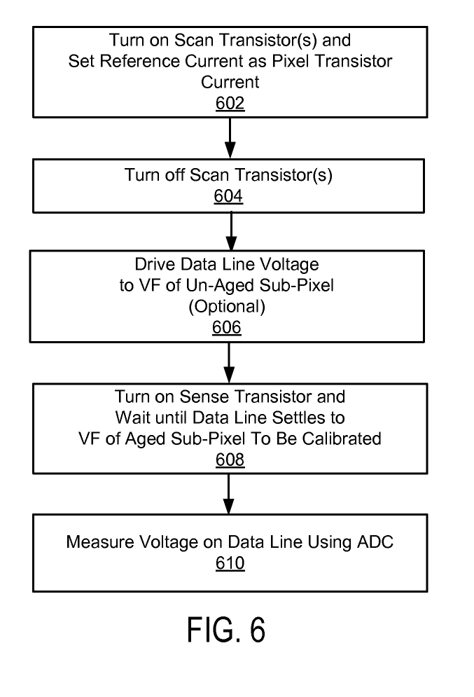

Current setting logic 412 includes logic that is configured to drive column DACs 306 with a reference voltage V_{REF} that corresponds to reference current I_{REF}, so that the OLED D0 in the sub-pixel in the AMOLED panel to be corrected for aging is driven with the reference current I_{REF}. The reference current I_{REF} is the constant current to be used for measuring the OLED forward voltage VF. The value of reference current I_{REF} may differ depending on the size of the AMOLED panel. In one embodiment, the reference current I_{REF} is 200 nA. In another embodiment, reference current I_{REF} is 1 μA. The reference voltage V_{REF} is provided to the sub-pixels through MUX 302 by turning on the switches SW1 (and turning off switches SW2) in MUX 302 via the data lines D of the sub-pixel to be calibrated. On the other hand, when the switches SW2 are turned on (and switches SW1 are turned off), the voltage (Vdata) 402 on the data line of the sub-pixel to be calibrated becomes coupled to aging calibration circuit 400 for measurement. As will be explained in more detail below with reference to FIG. 6, the measured data line voltage Vdata 402 may be substantially equal to the forward voltage VF of OLED D0 of the sub-pixel to be calibrated, under certain conditions. The sensed voltage Vdata is input to ADC 404, which outputs a digital value VF(aged) corresponding to Vdata. Difference block 406 includes logic circuitry configured to compute the difference in forward voltage ΔVF between VF (aged) and VF (un-aged). VF(un-aged) is digital forward voltage data VF corresponding to an un-aged OLED sub-pixel, that was measured previously using the calibration circuit 400 or by other means. ΔVF is stored in look-up table 408 which converts the ΔVF values to ΔGrayScale indicating the aging offset data in the form of offsets to the grayscale data that is needed to compensate for aging in the OLED sub-pixel to be calibrated. The look-up table 408 can perform such ΔVF to ΔGrayScale conversion using empirical data collected during the manufacture and testing stages of the AMOLED panel. ΔGrayScale is stored in aging offset RAM 704. Although in the embodiment of FIG. 4A the lookup table 408 converts ΔVF to ΔGrayScale for use as the aging offset data, in other embodiments the lookup table 408 may convert ΔVF to ×Luminance for use as the aging offset data.

The operation of FIG. 4A is explained herein together with reference to FIG. 6, which illustrates a method of measuring the forward voltage of an OLED in an AMOLED sub-pixel for aging calibration, according to one embodiment. Referring to FIG. 6 together with FIG. 4A, in step 602 one or more of the scan transistors M2 of the sub-pixels to be calibrated on a selected row of the AMOLED panel are turned on and current setting logic 412 sets the column DACs 306 corresponding to such sub-pixels with reference voltages V_{REF} that correspond to reference current I_{REF}. Preferably, the reference voltages V_{REF} that correspond to reference current I_{REF} is already calibrated for Mura, sub-pixel to sub-pixel, so that the aging calibration can be completed more efficiently and faster. During step 602, switches SW1 of MUX 302 is closed and switches SW2 of MUX 302 are opened, so that the data lines D of the sub-pixels to be calibrated become coupled to the column DAC 306. Also, the scan transistors M2 of the sub-pixels to be calibrated on the selected are turned so that the reference voltage V_{REF} can drive the pixel transistors M1. As a result of step 602, all the pixel transistors TFTs M1 in the sub-pixels of the selected row are forced to have the same reference current I_{REF} flowing through them.

In step 604, the scan transistors M2 of the sub-pixels to be calibrated in the selected row are turned off. Then, in step 606, the voltage on the data lines D of the sub-pixels to be calibrated in the selected row are driven to the OLED forward voltage VF of an un-aged pixel corresponding to the reference current I_{REF}, using current setting logic 412. This OLED forward voltage VF of an un-aged pixel may have been measured previously using the same techniques as described in FIG. 6 with respect to an un-aged sub-pixel of the AMOLED panel and stored. Switches SW1 are turned on and switches SW2 are turned off during step 606. Note that step 606 is optional, but is beneficial in preventing unwanted surge current from flowing through the OLEDs D0 of the sub-pixels to be calibrated.

In step 608, the sense transistor M3 of the sub-pixels to be calibrated on the selected row are turned on, and the process waits until the data line D of the sub-pixels settle to the forward voltage VF of the OLED D0 of the aged sub-pixel. Because the data line D of the sub-pixels is a capacitive load, once the data line D settles to the forward voltage VF of the OLED D0, all the current from the pixel transistor M1 flows through the OLED D0 and no current flows through the sense transistor M3, RGB MUX (not shown), and data line D. Thus, the voltage on the data line D becomes substantially equal to the forward voltage VF of the OLED D0, since there is no voltage drop on the data line D.

Then, in step 610, the voltage on the data line D of the sub-pixels is measured using ADC 404, as explained above. During step 610, switches SW1 are opened and switches SW2 are closed in the MUX 302 to disconnect the column DACs 306 from the data line D and connect the data line D to the aging calibration circuit 400. While steps 602, 604, 606, and 608 may be performed on all or multiple sub-pixels of the selected row of the AMOLED panel, step 610 is performed on each sub-pixel one at a time if there is only a single calibration circuit 400 with the ADC 404. Alternatively, the calibration circuitry 400 can be configured to include multiple ADCs 404 to measure the voltage on data line D of multiple sub-pixels at a time, in order to enhance the speed of image sticking calibration. As explained above, the measured data line voltage in step 610 is the forward voltage VF (aged) 714 of the aged sub-pixel, which is then compared with the forward voltage VF (un-aged) 716 of the un-aged sub-pixel to determine the difference ΔVF 712 between VF (aged) and VF (un-aged). ΔVF 712 is stored in look-up table 408 and converted to ΔGrayScale values indicating the aging offset data for storage in aging offset RAM 704.

By performing steps 602, 604, 606, 608, and 610, the aging calibration process for one selected row of the AMOLED panel is completed. These steps 602, 604, 606, 608, and 610 can be repeated for other rows of the AMOLED panel, row by row, to complete the aging calibration process for the entire AMOLED panel. At the end of that process, the aging offset RAM 704 would store aging offset data (ΔGrayScale values) for each of the sub-pixels of the entire AMOLED panel.

The circuitry and method for measuring the forward voltage VF of OLEDs as described in FIGS. 4A and 6 have several benefits. First, since in step 602 the pixel transistors M1 are used as current sources for driving the OLEDs D0 with the reference current simply by setting the reference voltage V_{REF}, no separate external current source is needed to drive the OLEDs D0. Even though data line D is a capacitive load with parasitic capacitance, potentially taking some time to settle to the forward voltage VF on OLED D0, it is possible to process aging calibration in all the sub-pixels of the selected row in parallel and thereby speed up aging calibration time, because each of the sub-pixels has its own current source, i.e., the pixel transistor M1, and does not need a separate, external current source. In addition, since the current from the pixel transistor M1 flows through the OLED D0 and no current flows through the sense transistor M3, RGB MUX, and data line D in steps 608 and 610, the resistance of the data line D does not introduce any inaccuracy in measuring the forward voltage of the OLED D0 and the voltage on data line D becomes substantially equal to the forward voltage VF of OLED D0, thereby providing a convenient point (the data line D) to measure the OLED forward voltage VF. Furthermore, temperature differences in the OLED sub-pixel do not introduce significant error either, because the effects on the forward voltage VF introduced by temperature differences our canceled out by subtracting the same un-aged forward voltage VF (un-aged) from each of the measured aged OLED forward voltage VF (aged). Also, the forward voltage VF (aged) on the data line D can be measured using a very simple ADC 404 without complicated analog circuitry.

FIG. 4B illustrates one example of the analog-to-digital converter (ADC) that can be used with the image sticking calibration circuit of FIG. 4A, according to one embodiment. ADC 404 is a successive-approximation-register (SAR) ADC and includes SAR logic 450, decoder 452, and comparator 456. SAR logic 450 implements a binary search algorithm to determine the digital output VF (aged) 714 corresponding to the measured voltage Vdata 402 on the data line D of the sub-pixel. Decoder 452 converts the binary values 458 output by SAR logic 450 to an analog value 460 comparably scaled to the data line voltage for comparison with the data line voltage Vdata 402 in comparator 456. Feedback loop 470 provides the output of comparator 456 to SAR logic 450 so that SAR logic continues the binary search until the value 460 approximates the data line voltage Vdata 402, which is output as VF (aged) 714 for the sub-pixel to be calibrated. Although a SAR ADC is used in FIG. 4B, the aging calibration circuit 400 is not limited to a particular type of ADC and a variety of other types of ADC circuits may be used with the aging calibration circuit 400.

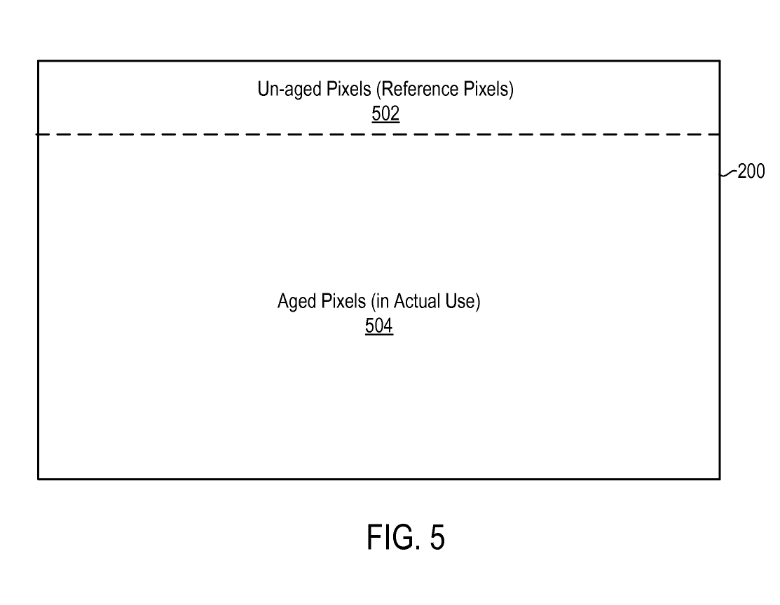

FIG. 5 illustrates how un-aged reference pixels are included in the AMOLED display, according to one embodiment. The AMOLED panel 200 may include a section 502 including sub-pixels (reference sub-pixels or replica sub-pixels) that are not used in normal operation. These un-aged OLED sub-pixels 502 are present on the AMOLED panel 200 but are not part of the active display. Since the reference pixels 502 are not used, they retain the initial characteristics of the sub-pixel at the time of manufacture of the AMOLED panel, i.e., they are un-aged. The OLED forward voltage VF (un-aged) of these un-aged sub-pixels 502 may be measured using the same aging calibration circuitry 400 of FIG. 4A and the method of FIG. 6, so that the aging calibration circuitry can use VF (un-aged) in difference block 406. In other embodiments, the OLED forward voltage VF (un-aged) of these un-aged sub-pixels 502 may be measured by other conventional means, not using the aging calibration circuitry 400 of FIG. 4A. The AMOLED panel 200 also includes a section 504 including sub-pixels that are actually used in normal operation and thus are aged. The sub-pixels 504 are the ones that require aging calibration as they age. The OLED forward voltage VF (aged) of these aged sub-pixels 504 are measured as explained above using the aging calibration circuitry 400 of FIG. 4A and the method of FIG. 6.

FIG. 7 illustrates the generation of compensated RGB data that is stored in column DAC register 702 which drives the column DAC 306 for real-time display by adding the scaled Mura and image sticking (aging) offset data to the RGB data in real time, according to one embodiment of the present invention. The Mura offset RAM 706 and the aging offset RAM 704 store offset gray scale values for correction of the RGB data 724 in order to compensate for Mura and aging, respectively, in the AMOLED display. The offset data for Mura compensation may be determined in a variety of conventional ways, which are not the subject of the invention herein and are not described herein. Data in the aging offset RAM 704 are entered through the aging calibration process described above with reference to FIGS. 4A and 6.

For aging compensation, the un-aged OLED diode forward voltage VF (un-aged) 716 of each sub-pixel for un-aged sub-pixels conducting the predetermined constant OLED diode current (I_{REF}) may be compared with the forward voltage VF(aged) 714 of aged OLEDs needed to have the same predetermined constant OLED current (I_{REF}) flow in aged OLEDs D0, to determine the difference ΔVF 712 in such forward voltages and infer how aged the OLED D0 is. The forward voltage difference ΔVF 712 is used as an index into a look-up table 710 that stores factory-determined full-scale aging offset data needed to compensate for such aging in the OLEDs as a function of the inferred age of the OLED diode indicated by ΔVF 712. Such aging offset data is stored in the aging offset RAM 704 at a location corresponding to the calibrated sub-pixel.

The data stored for each sub-pixel in the offset RAMs 704 and 706 corresponds to the correction needed for full-scale pixel current (e.g., M1 pixel current Ip=200 nA) which corresponds to a full-scale RGB data. For real-time display, the data in the offset RAMs 704 and 706 should be scaled according to the real-time RGB data so that full-scale offsets are scaled accordingly for less than full-scale RGB input data. Mura offset data scaler 718 and aging offset data scaler 720 scale the full-scale Mura offset data and the full-scale aging offset data, respectively, to correspond to the real-time RGB data 724 for the driven sub-pixel. Adder 722 performs real-time addition of the scaled Mura offset value 732 and the scaled aging (image sticking) offset value 734 to the real-time RGB data 724 corresponding to the driven sub-pixel, and the summed result is stored temporarily in column DAC registers 702 as compensated RGB data for driving the column DAC 306 that subsequently drives the sub-pixels for real-time display. Thus, the OLED sub-pixels will illuminate light calibrated for Mura and especially for aging, as determined by the process illustrated above in FIG. 6.

Upon reading this disclosure, those of skill in the art will appreciate still additional alternative designs for correction of aging in AMOLED displays. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the present invention.

What is claimed is:

1. An active matrix organic light-emitting diode (AMOLED) display device, comprising:
a plurality sub-pixels arranged in rows and columns, each sub-pixel including at least an organic light-emitting diode (OLED), a first transistor for driving the OLED, a storage capacitor for turning on or off the first transistor according to charges stored in said storage capacitor, a second transistor for connecting a data line of said each sub-pixel to the storage capacitor and the first transistor, and a third transistor for connecting the OLED to the data line; and
calibration circuitry configurable to be coupled to at least one of the sub-pixels and adapted to measure a forward voltage of the OLED via the data line when a reference current flows through the OLED.

2. The AMOLED display device of claim 1, wherein the calibration circuitry includes an analog-to-digital converter (ADC) configured to be coupled to the data line of said each sub-pixel to measure a data line voltage on the data line, the data line voltage being substantially equal to the forward voltage of the OLED.

3. The AMOLED display device of claim 2, wherein the calibration circuitry further includes a difference block configured to determine a forward voltage difference between the measured data line voltage and a predetermined reference forward voltage corresponding to an un-aged reference OLED, the forward voltage difference being an indicator of aging of the OLED.

4. The AMOLED display device of claim 3, wherein the calibration circuitry is configured to drive the data line to the reference forward voltage prior to measuring the data line voltage on the data line.

5. The AMOLED display device of claim 2, further comprising multiplexing circuitry including a first switch and a second switch, the first switch configured to be turned on to connect the data line to a reference voltage corresponding to the reference current for driving the OLED while the second switch is turned off, and the second switch configured to be turned on to connect the data line to the analog-to-digital converter for measurement of the data line voltage while the first switch is turned off.

6. The AMOLED display device of claim 2, wherein the ADC is a successive-approximation-register (SAR) type ADC.

7. The AMOLED display device of claim 1, wherein the first transistor drives the reference current through the OLED.

8. The AMOLED display device of claim 1, wherein the second transistor is turned off while the calibration circuitry measures the forward voltage of the OLED via the data line.

9. The AMOLED display device of claim 1, wherein the third transistor is turned on to connect the OLED to the data line by at least a predetermined time prior to measuring the data line voltage on the data line such that the forward voltage of the OLED settles on the data line.

10. In an active matrix organic light-emitting diode (AMOLED) display device including a plurality sub-pixels arranged in rows and columns, each sub-pixel including at least an organic light-emitting diode (OLED), a first transistor for driving the OLED, a storage capacitor for turning on or off the first transistor according to charges stored in said storage capacitor, a second transistor for connecting a data line of said each sub-pixel to the storage capacitor and the first transistor, and a third transistor for connecting the OLED to the data line, a method of determining an age of said OLED, the method comprising:
driving the first transistor with a reference current, the reference current also being driven through said OLED by the first transistor; and
measuring a data line voltage on the data line of each of said sub-pixel when the reference current flows through the OLED, the data line voltage being substantially equal to a forward voltage of said OLED when the reference current flows through said OLED.

11. The method of claim 10, wherein the data line voltage is measured using an analog-to-digital converter (ADC) coupled to the data line of said each sub-pixel.

12. The method of claim 11, further comprising determining a forward voltage difference between the measured data line voltage and a predetermined reference forward voltage corresponding to an un-aged reference OLED, the forward voltage difference being an indicator of the age of the OLED.

13. The method of claim 12, further comprising driving the data line to a reference forward voltage corresponding to an un-aged OLED, prior to measuring the data line voltage.

14. The method of claim 11, further comprising turning on the second transistor and connecting the data line to a reference voltage corresponding to the reference current to drive the reference current through the first transistor and said OLED.

15. The method of claim 11, further comprising turning off the second transistor while the data line voltage is measured.

16. The method of claim 11, further comprising turning on the third transistor to connect the OLED to the data line by at least a predetermined time prior to measuring the data line voltage such that the forward voltage of the OLED settles on the data line.

17. Calibration circuitry for correcting aging of the organic light-emitting diodes (OLEDs) in an active matrix organic light-emitting diode (AMOLED) display device, the calibration circuitry comprising:
an analog-to-digital converter (ADC) configured to be coupled to a data line of each sub-pixel of the AMOLED display to measure a data line voltage on the data line while an OLED of said each sub-pixel is driven by a reference current, the data line voltage being substantially equal to the forward voltage of the OLED; and
a difference block configured to determine a forward voltage difference between the measured data line voltage and a predetermined reference forward voltage corresponding to an un-aged reference OLED, the forward voltage difference being an indicator of an age of the OLED.

18. The calibration circuitry of claim 17, wherein the calibration circuitry is configured to drive the data line to the reference forward voltage prior to the ADC measuring the data line voltage.

19. The calibration circuitry of claim 17, wherein the ADC is a successive-approximation-register (SAR) type ADC.

20. The calibration circuitry of claim 17, wherein said OLED is connected to the data line prior to the calibration circuitry measuring the data line voltage by at least a predetermined time.
